(19) United States
(12) Patent Application Publication
(10) Pub. No.: US 2014/0325443 A1
(43) Pub. Date: Oct. 30, 2014

(54) METHOD AND APPARATUS FOR OPERATING MENU IN ELECTRONIC DEVICE INCLUDING TOUCH SCREEN

(71) Applicant: Samsung Electronics Co., Ltd., Gyeonggi-do (KR)

(72) Inventors: Geonsoo Kim, Gyeonggi-do (KR); Yongjoon Jeon, Gyeonggi-do (KR)

(73) Assignee: Samsung Electronics Co., Ltd., Gyeonggi-do (KR)

(21) Appl. No.: 14/261,274

(22) Filed: Apr. 24, 2014

(30) Foreign Application Priority Data
Apr. 24, 2013 (KR) 10-2013-0045270

(51) Int. Cl. G06F 3/0482; G06F 3/0488

(52) U.S. Cl. CPC G06F 3/0482; G06F 3/0488
USPC 715/825

(57) ABSTRACT

There is provided a method of operating a menu in an electronic device, including displaying the execution screen of a specific function on a touch screen, detecting a touch gesture having an arc trajectory in the state in which the execution screen is displayed, and displaying an arc trajectory menu related to the specific function in response to a touch gesture having the arc trajectory.

### CROSS-REFERENCE TO RELATED APPLICATION(S) AND CLAIM OF PRIORITY

The present application is related to and claims the benefit under 35 U.S.C. §119(a) of a Korean patent application filed on Apr. 24, 2013 in the Korean Intellectual Property Office and assigned Serial No. 10-2013-0045270, the entire disclosure of which is hereby incorporated by reference.

### TECHNICAL FIELD

The present disclosure relates to a method and apparatus for operating a menu in an electronic device, and more particularly, to a method and apparatus for operating a menu in an electronic device including a touch screen.

### BACKGROUND

With the recent development of communication technology, user devices, for example, portable terminals, such as smart phones and tablet PCs, come into wide use. A portable terminal is being used in very wide fields due to its use convenience and easy portability. In particular, a portable terminal equipped with a touch screen continues to be developed. As functions provided by a portable terminal are enriched, user interactions for touch manipulations in a portable terminal tend to be complicated.

A recent portable terminal provides various functions, for example, various and new functions, such as photographing, the edition of photos, and the writing of documents, in addition to communication service. As a portable terminal provides complicated and various functions, the operation of the portable terminal becomes complicated. For example, a user needs to hierarchically enter menus from an upper menu to a lower menu in order to use detailed functions. That is, a user has to manipulate several touches onerously in order to execute a desired function in a portable terminal. Furthermore, a menu structure having a depth (e.g., an upper menu->a lower menu) is not intuitive to a user, and a user has to onerously search for a desired function if he or she is unaware of the position of a menu for the desired function.

A conventional portable terminal may provide only communication service simply, and the size of the portable terminal was gradually reduced in order to enhance a function that is manipulated by one hand. In contrast, the size of a recent portable terminal is gradually increased in line with a user's need rather than a function manipulated by one hand. As the size of a portable terminal is increased, there is a problem in that it is difficult to manipulate a touch screen by one hand because the touch screen is increased in size. In the embodiment of a portable terminal having a large touch screen, it is a great burden for a user to manipulate input, such as a menu, using one hand in the state in which the user holds the portable terminal using the other hand. If a user holds a portable terminal having a large touch screen using only one hand, there is a disadvantage in that the portable terminal is stable. In contrast, if a user holds a portable terminal using both hands, there is a disadvantage in that the hand's utilization is low because a region in which the user can control input is limited. Accordingly, there is a need for a user interface through which a menu function according to the execution of a function can be used more intuitively and easily as detailed menus for a specific function become complicated in a portable terminal.

### SUMMARY

To address the above-discussed deficiencies, it is a primary object to provide a method and apparatus for operating a menu in an electronic device, which are capable of controlling detailed menus for a specific function with a minimum touch movement in the electronic device equipped with a touch screen.

The present disclosure may provide a method and apparatus for operating a menu in an electronic device, which are capable of intuitively providing function menus to a user using only a region in which input can be controlled by the thumb in the state in which the user holds the electronic device equipped with a touch screen using a hand or both hands and of enabling rapid access to menus and rapid execution of functions.

In accordance with an aspect of the present disclosure, a method of operating a menu in an electronic device includes displaying the execution screen of a specific function on a touch screen, detecting a touch gesture having an arc trajectory in the state in which the execution screen has been displayed, and displaying an arc trajectory menu related to the specific function in response to a touch gesture having the arc trajectory.

The method may further include detecting a manipulation input gesture for an arc trajectory menu based on a touch input time and a touch movement in the state in which the arc trajectory menu has been displayed and executing a function of manipulating the arc trajectory menu in response to the manipulation input gesture for the arc trajectory menu.

In accordance with another aspect of the present disclosure, an electronic device includes a touch screen displaying the execution screen of a specific function and displaying an arc trajectory menu for the specific function and a control unit detecting a touch gesture having an arc trajectory in the state in which the execution screen of the specific function has been displayed and performing control such that an arc trajectory menu related to the specific function is displayed in response to a touch gesture having the arc trajectory.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram showing the construction of a terminal in accordance with an embodiment of the present disclosure.

FIG. 2 illustrates a process for a method of operating a menu in the terminal including a touch screen in accordance with an embodiment of the present disclosure.

FIG. 3 illustrates an example diagram showing a user interface through which the display of an arc trajectory menu is controlled in accordance with the present disclosure.

FIG. 4 illustrates an example diagram showing a user interface through which the display of an arc trajectory menu is fixed in accordance with the present disclosure.

FIG. 5 illustrates an example diagram showing an operation of releasing an arc trajectory menu in accordance with the present disclosure.

FIG. 6 illustrates an example diagram showing an operation of changing an arc trajectory menu in accordance with the present disclosure.

FIG. 7 illustrates a process for a method of operating an arc trajectory menu of the terminal in accordance with an embodiment of the present disclosure.

FIG. 8 illustrates an example diagram showing the operations of arc trajectory menus of the terminal in accordance with an embodiment of the present disclosure.

### DETAILED DESCRIPTION

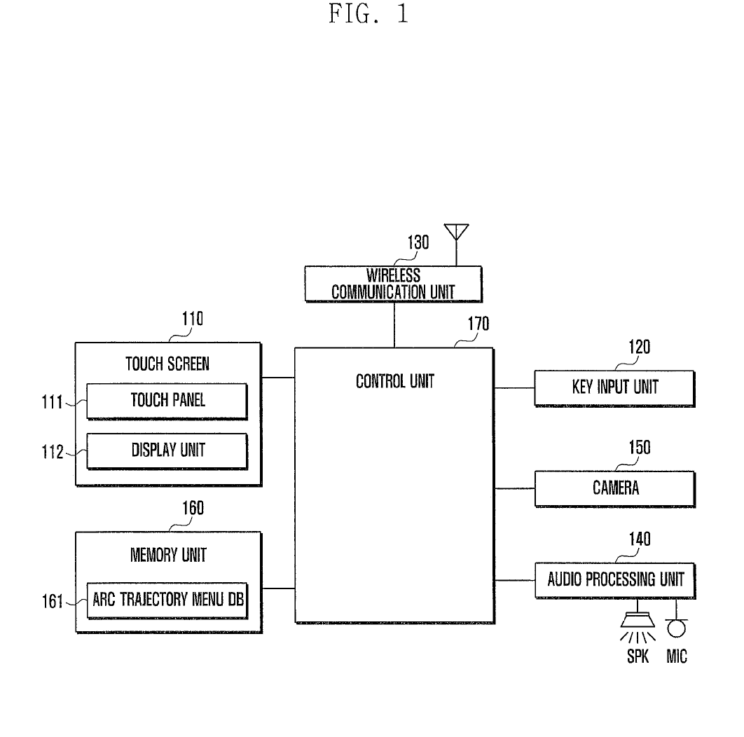

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or method. Hereinafter, example embodiments of the present disclosure are described in detail with reference to the accompanying drawings. Prior to a detailed description of the present disclosure, terms or words used hereinafter should not be construed as having common or dictionary meanings, but should be construed as having meanings and concepts that comply with the technical field of the present disclosure. Accordingly, the following description and drawings illustrate embodiments of the present disclosure and do not limit the scope of the present disclosure. It would be understood by one of ordinary skill in the art that a variety of equivalents and modifications of the embodiments exist. Furthermore, in the accompanying drawings, some elements are illustrated as being enlarged and are illustrated schematically, and the size of each element does not accurately reflect its real size. Accordingly, the present disclosure is not restricted by the relative sizes or spaces that are drawn in the figures. A detailed description of known functions or constructions related to the present disclosure will be omitted where such a description would obscure the present disclosure in unnecessary detail.

A user device in accordance with the present disclosure provides a user interface through which menus can be controlled using only a region in which the thumb can be moved in the state in which a user holds the user device using both hands. The user device in accordance with the present disclosure provides a function of displaying one or more menu objects of a specific function in an arc trajectory and a function of executing detailed function in response to a touch manipulation for a limited region, when a touch gesture of the arc trajectory is inputted to the limited region in the state in which a screen in which the specific function is executed has been displayed.

The method and apparatus in accordance with the present disclosure may be applied to a portable terminal. It is evident that such a portable terminal may be a mobile phone, a smart phone, a tablet PC, a handheld PC, a Portable Multimedia Player (PMP), or a Personal Digital Assistant (PDA). In the following description, it is assumed that a method and apparatus for operating a menu in an electronic device in accordance with the present disclosure is applied to a terminal.

FIG. 1 illustrates a block diagram showing the construction of a terminal in accordance with an embodiment of the present disclosure.

Referring to FIG. 1, the terminal 100 in accordance with the present disclosure may be configured to include a touch screen 110 configured to include a touch panel 111 and a display unit 112, a key input unit 120, a wireless communication unit 130, an audio processing unit 140, a camera 150, a memory unit 160 and a control unit 170.

The touch screen 110 displays a screen according to the execution of a function or an application and senses a touch event related to control of a function. The touch panel 111 is placed on the display unit 112. Concretely, the touch panel 111 may be implemented in an add-on type in which the touch panel 111 is placed at the front of the display unit 112 or an on-cell type or an in-cell type in which the touch panel 111 is inserted into the display unit 112. The size of the touch screen 110 may be determined by the size of the touch panel 111. The touch panel 111 generates an analog signal (e.g., a touch event) in response to user input information (e.g., a user gesture) for the touch panel 111, converts the analog signal into a digital signal, and transfers the digital signal to the control unit 170. The touch event includes information on touch coordinates (X,Y). The control unit 170 determines that a touch tool (e.g., a finger or pen) has touched the touch screen when a touch event is received from the touch screen 110 and determines that a touch has been released when a touch event is not received from the touch screen 170. Furthermore, when touch coordinates are changed, the control unit 170 determines that a touch has moved and calculates a change of the position of the touch and moving speed of the touch in response to the movement of the touch. The control unit 170 determines a user gesture based on touch coordinates, whether or not a touch has been released, whether or not a touch has been moved, a change of the position of a touch, and moving speed of a touch. The touch panel 111 can be applied to a resistive type, a capacitive type, and an electromagnetic induction type.

The display unit 112 converts image data, received from the control unit 170, into an analog signal and displays the analog signal under the control of the control unit 170. That is, the display unit 112 can provide various screens according to the use of the terminal, for example, a lock screen, a home screen, an application execution screen, a menu screen, a keypad screen, a message writing screen, and an Internet screen. The display unit 112 may be formed in the form of a flat panel display unit, such as a Liquid Crystal Display (LCD), Organic Light Emitted Diodes (OLED), or Active Matrix Organic Light Emitted Diodes (AMOLED).

The touch screen 110 in accordance with the present disclosure supports a function of recognizing an arc trajectory drawn on a screen in the application execution screen and supports a function of outputting an arc trajectory menu related to a specific function along the recognized arc trajectory. The arc trajectory menu may include one or more menu objects that are related to a specific function of the terminal 100. The arc trajectory menu can be displayed on the display unit 112 in an arc trajectory to which a user input has been recognized under the control of the control unit 170. The arc trajectory menu may be displayed in a region in which an arc trajectory input operation is possible if the terminal 100 is held by a hand in a specific direction. The region in which the arc trajectory input operation is possible may be considered to be the length of the thumb of each user. For example, if a specific user holds the terminal using both hands, the specific user may perform a touch input to the touch screen 110 using the thumb in the state in which the user holds the side and back of the terminal using four fingers other than the thumb. The length of the thumb determines a range in which specific positions of menus outputted in response to an arc trajectory can be freely selected. That is, the arc trajectory menu can be outputted within a range determined by the thumb of a hand that holds the terminal.

The terminal 100 of the present disclosure supports a function of enabling a user to select the menu of a specific function without moving a hand by controlling the position of an arc trajectory menu outputted depending on the length of the thumb in the state in which the user holds the terminal 100 using only one hand or both hands. The display unit 112 can support a function of displaying an arc trajectory menu in a horizontal mode and an arc trajectory menu in a vertical mode depending on the direction in which the terminal 110 is rotated (or the direction in which the terminal 110 is placed) and a function of displaying an adaptive screen switch according to a change between the horizontal mode and the vertical mode.

The key input unit 120 includes a plurality of input keys and function keys for receiving numerical or alphabetic information and setting various functions. The key input unit 120 generates key signals that are related to user setting and control of the functions of the terminal and transfers the key signals to the control unit 170. The key signals may be classified into power on/off signals, a volume control signal, and screen on/off signals. The control unit 170 can control the aforementioned elements in response to the key signals.

The wireless communication unit 130 supports a communication function performed by the terminal 100. The wireless communication unit 130 forms a communication channel along with a supportable mobile communication network and performs communications, such as voice communication, video communication, and data communication. The wireless communication unit 130 may include a radio frequency transmission unit for performing up-conversion and amplification on the frequency of a transmitted signal and a radio frequency reception unit for performing low noise amplification and down-conversion on the frequency of a received signal.

The audio processing unit 140 converts digital audio data, such as voice received from the control unit 170, into analog audio data, sends the analog audio data to a speaker SPK, converts analog audio data, received from a microphone MIC, into digital audio data, and transfers the digital audio data to the control unit 170. The audio processing unit 150 may include a codec (i.e., coder/decoder). The codec may include a data codec for processing packet data and an audio codec for processing an audio signal, such as voice.

The audio processing unit 140 in accordance with the present disclosure can support the output of a sound effect according to an operation of an arc trajectory menu. For example, when a function of fixing an arc trajectory menu outputted to the display unit 112 is set, the audio processing unit 140 may output a sound effect (e.g., a rattling sound) notifying that the function of fixing the arc trajectory menu has been set. The output of the sound effect may be omitted depending on user setting or a designer's intention.

The memory unit 160 stores various data generated from the terminal 100 in addition to an Operating System (OS) and various applications for the terminal 100. The data may include data generated when applications are executed and all types of data generated using the terminal or received from an external device (e.g., an external server, another terminal, and a PC). The memory unit 160 can store user interfaces provided by the terminal 100 and various pieces of configuration information related to the processing of terminal functions.

The memory unit 160 may include an arc trajectory menu database (DB) 161. Furthermore, the memory unit 160 may include information on an arc trajectory menu outputted to the display unit 112 and an input algorithm program that supports the operations of arc trajectory menus. The information on an arc trajectory menu may include menu objects for a specific function. For example, an arc trajectory menu for a camera function may include objects for camera operation functions (e.g., a change of a mode, a change of picture quality, a change of an effect, a change of sensitivity, a change of resolution, and a change of a focus). In the present disclosure, the arc trajectory menu may have a type in which objects are disposed in an arc trajectory.

The control unit 170 performs a function of controlling the overall operation of the terminal and a flow of signals between the internal elements of the terminal and processing data. The control unit 170 controls the supply of power from a battery to the internal elements. When power is supplied, the control unit 170 controls a process of booting up the terminal and executes various applications stored in a program region in order to execute the functions of the terminal in response to user setting.

The control unit 170 determines whether or not a touch input received from the touch screen 110 is an arc trajectory menu display gesture. If, as a result of the determination, the touch input is determined to be an arc trajectory menu display gesture, the control unit 170 instructs the display unit 112 to display an arc trajectory menu and outputs the arc trajectory menu to the display unit 112. The control unit 170 detects the rotation of the terminal and supports a change of at least one of the position and shape of an arc trajectory menu that is outputted in response to the rotation of the terminal. For example, if the rotation state of the terminal is changed from a vertical mode to a horizontal mode, the control unit 170 can control an arc trajectory menu in a specific hand direction such that the arc trajectory menu is positioned in a region of the display unit 112 according to the change of the rotation of the arc trajectory menu and outputted by controlling the positions of menus. When a specific input signal for a function of changing an arc trajectory menu, releasing the display of the arc trajectory menu, fixing the display of the arc trajectory menu, or displaying submenus of the arc trajectory menu is generated in the state in which the arc trajectory menu has been displayed, the control unit 170 supports that the function is executed in response to the specific input signal.

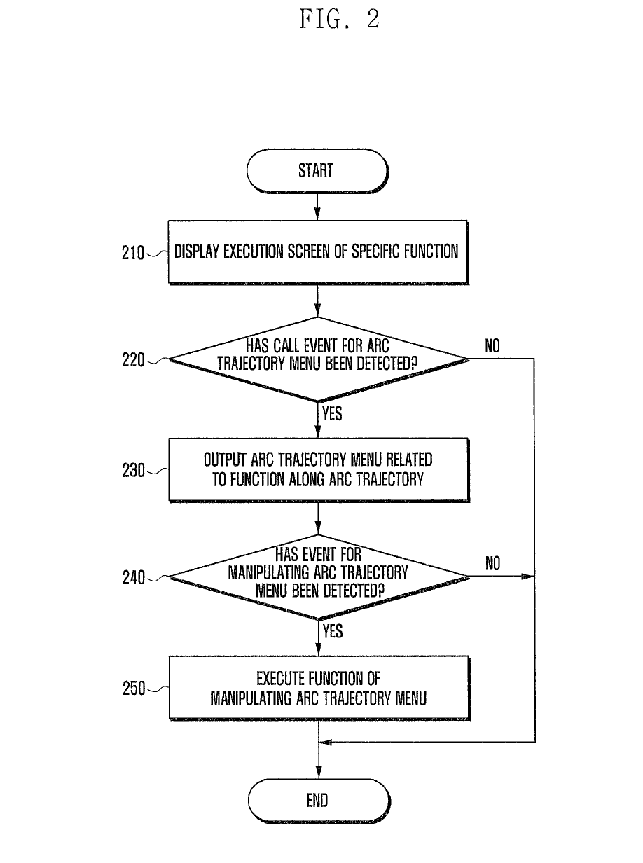

A detailed operational process of the terminal is described with reference to FIG. 2.

All elements of the terminal may not be enumerated because the terminal is modified in various ways according to the convergence trend of digital devices, but the terminal 100 in accordance with the present disclosure may further include elements not described above, such as a sensor module for sensing information related to a change in the position of the terminal 100 and a GPS module for measuring the position of the terminal 100. Furthermore, specific elements of the terminal 100 according to the present disclosure may be excluded or replaced with other elements depending on a type in which the terminal 100 is provided. Furthermore, in the present disclosure, in addition to the touch screen 110 and the key input unit 120, a touch pad or a track ball may become the input unit.

FIG. 2 illustrates a process for a method of operating a menu in the terminal including the touch screen in accordance with an embodiment of the present disclosure.

Referring to FIG. 2, at operation 210, the control unit 170 activates an application necessary to operate an arc trajectory menu in response to a user's input and displays a screen in which the application is executed on the display unit 112. The application necessary to operate an arc trajectory menu may be an application corresponding to at least one of a camera function, a gallery function, an Internet browser function, a scheduler function, a memo function, and a moving image function, but the present disclosure is not limited thereto.

At operation 220, the control unit 170 determines whether or not a call event to call an arc trajectory menu is detected in the state in which the application execution screen has been displayed. The arc trajectory menu call event may be detected in a limited region, for example, in a region in which a touch input can be controlled by the thumb in the state in which a user holds the terminal using a hand or both hands. For example, if a user holds the terminal 100 using both hands, the user may have a range in which a touch can be performed in a fan shape using the thumb. The terminal 100 can detect a touch gesture for an arc trajectory in the range in which a touch can be performed in a fan shape using the thumb. The arc trajectory menu call event may be a touch gesture signal drawn in an arc trajectory, but the present disclosure is not limited thereto.

Concretely, the control unit 170 detects coordinate data in a touch input signal that is received from the touch screen 110 at a specific time interval. For example, the control unit 170 extracts the coordinates of a touch input transmitted at a specific time interval, touch start (e.g., touch-down) coordinates, and touch end (e.g., a specific time long press not including touch-up or a change of the position) coordinates. The control unit 170 can detect a touch gesture having an arc trajectory from a line form that connects the extracted coordinates.

The arc trajectory menu call event may be an arc trajectory touch gesture which is started from the bezel region of the touch screen and ended at a display region or an input signal for a touch gesture that is drawn in two arc trajectories at the same time, but the present disclosure is not limited thereto.

The control unit 170 can support signal control and signal processing for performing a corresponding user function when a function execution request event for an application is detected in the state in which an application execution screen has been displayed. For example, when a drag input event in a specific direction is detected in the state in which a gallery function has been executed, the control unit 170 can perform a function of outputting a photo displayed on a screen to a next list of photos.

If, as a result of the determination at operation 220, the arc trajectory menu call event is determined to have been detected, the control unit 170 outputs an arc trajectory menu related to a specific function along the arc trajectory at operation 230. The control unit 170 controls menus related to the function of an application such that the menus are outputted to a limited region, for example, to a region in which a touch input can be controlled by the thumb in an arc trajectory. The control unit 170 can control the arc trajectory menu such that the arc trajectory menu is outputted in the form of a line drawn by the touch gesture of an arc trajectory, that is, along the arc trajectory drawn by a touch. A basic form of the arc trajectory may be a fan-shaped arc trajectory, and the fan-shaped arc trajectory may have a different shape depending on the direction of a left hand or a right hand. The fan-shaped arc trajectory menu may be defined based on predetermined default information or may be directly set by a user. The control unit 170 can support a function of outputting the arc trajectory menu in a form in which the terminal is disposed, that is, in a form in which the terminal is disposed in a horizontal mode or a vertical mode.

At operation 240, the control unit 170 determines whether or not a menu manipulation event for manipulating the arc trajectory menu is detected in the state in which the arc trajectory menu has been displayed. The menu manipulation event can be detected in a limited region, for example, in a region in which a touch input can be controlled by the thumb in the state in which a user holds the terminal using a hand. The menu manipulation event for manipulating the arc trajectory menu may be an event generated by at least one of a touch, a multi-touch, a tap, a double tap, a long tap, a drag, a flick, a press, a long press, and touch-up hovering in the state in which the arc trajectory menu has been displayed. The menu manipulation event for manipulating the arc trajectory menu may be defined based on predetermined default information or may be directly set by a user.

If, as a result of the determination at operation 240, a menu manipulation event for manipulating the arc trajectory menu is determined to have been detected, the control unit 170 executes a function of manipulating the arc trajectory menu which has been mapped in response to the menu manipulation event, at operation 250. The function of manipulating the arc trajectory menu may include at least one of a menu display fixing function, a menu display release function, a menu selection function, a selection menu execution function, a menu change function, and a lower menu call function.

For example, the menu display fixing function may be executed in response to a touch event that moves in the central direction of an arc trajectory in the state in which an arc trajectory menu has been called. The menu display release function may be executed in response to a touch-up event that is generated within a predetermined time in the state in which an arc trajectory menu has been called or a touch event that moves in the outside direction of an arc trajectory in the state in which the display of an arc trajectory menu has been fixed. In the menu selection function, one menu may be selected in response to a touch event that is maintained for a predetermined time in the state in which an arc trajectory menu has been called. The selection menu execution function may be executed in response to a touch-up event or a touch event drawn in an arc trajectory in another region, after an arc trajectory menu is selected. In the menu change function, an outputted menu can be changed in response to a touch event that moves in an arc direction in the state in which the display of an arc trajectory menu has been fixed. The lower menu call function may be executed in response to a touch event that is drawn in an arc trajectory in another region in the state in which one menu of an arc trajectory menu has been selected. A lower menu can be outputted to a region in which input can be controlled by the thumbs of both hands other than a region to which an arc trajectory menu has been outputted, that is, a region in which input can be controlled by the thumb of one hand.

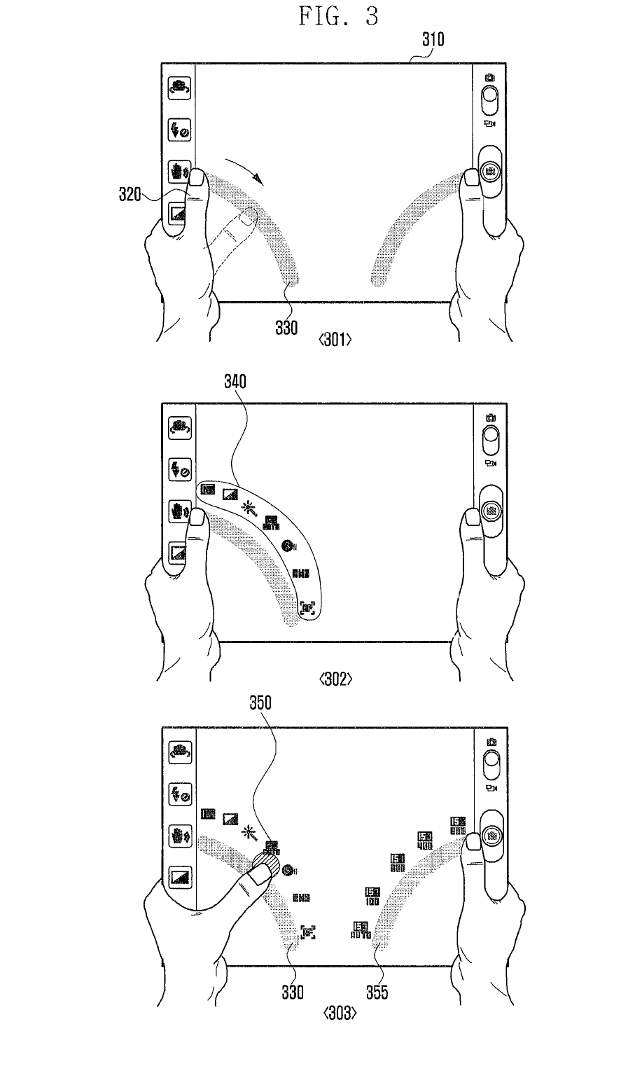

Example screens related to a function of manipulating an arc trajectory menu are described in detail below with reference to FIGS. 3 to 6.

FIG. 3 illustrates an example diagram showing a user interface through which the display of an arc trajectory menu is controlled in accordance with the present disclosure.

Referring to FIG. 3, the display unit 112 can output a screen 310 in which an application necessary to operate an arc trajectory menu is executed in response to a user input. The application necessary to operate an arc trajectory menu may include an application that supports detailed menus, such as a camera, a message, a gallery, a scheduler, and an Internet browser, but the present disclosure is not limited thereto. For example, when an input signal to request the activation of a camera application is generated, the terminal activates the camera application and displays a camera application execution screen 310 on the display unit 112, as shown in a screen 301. The camera application execution screen 310 may be provided in the form of a full screen depending on user setting or whether or not the terminal supports the full screen. Furthermore, the terminal 100 may provide the camera application execution screen 310 in a horizontal mode or may provide the camera application execution screen 310 in a vertical mode or a horizontal mode in response to the rotation of the terminal 100. The camera application execution screen 310 has been illustrated as being provided in a vertical mode in FIG. 3, but the present disclosure is not limited thereto.

A user may generate a predetermined gesture input in order to call an arc trajectory menu in the state in which the user holds the terminal 100 using both hands. Here, the gesture predetermined in order to call the arc trajectory menu may be an operation of drawing an arc trajectory in a limited region. That is, the user can draw an arc trajectory 330 on the screen using the thumb 320.

When the input event drawn along the arc trajectory is generated, the terminal 100 outputs an arc trajectory menu 340 to the display unit 110 as shown in a screen 302. A region to which the arc trajectory menu 340 is outputted may be a region corresponding to a range in which the user can touch outputted menu objects using the thumb in the state in which the user holds the terminal 100.

The arc trajectory menu 340 can be outputted in a form in which at least one menu object related to an activated application is disposed along the arc trajectory. For example, the arc trajectory menu 340 of the camera application may include at least one of menu objects, such as a photographing mode change menu, a picture quality change menu, an effect function menu, a sensitivity change menu, a resolution change menu, a white balance change menu, and a focus change menu. In the arc trajectory menu 340, outputted menu objects can be changed in response to an application activated in the terminal 100.

The user may input an operation of requesting the menu selection function, the selection menu execution function, or the lower menu call function at the position of a menu object to be executed in the state in which the arc trajectory menu 340 has been displayed. In response to the menu execution gesture, the terminal 100 can execute a menu function outputted to the position at which a touch gesture has been generated or call a lower arc trajectory menu for a menu. Here, a menu execution operation or a lower menu call operation may correspond to an operation of maintaining a touch on a specific menu for a specific time in the state in which the arc trajectory menu has been displayed or an operation of maintaining a touch on a specific menu for a specific time and releasing the touch. Such a menu execution operation may be changed depending on user setting or setting upon fabrication.

For example, as shown in a screen 303, the user may input an operation of maintaining a touch for a specific time in a region in which a specific object 350 has been disposed and releasing the touch. In response thereto, the terminal 100 can support a function of outputting the lower menus 355 of the specific object 350 to a right region in an arc trajectory. The user can operate the lower menus 355 of the arc trajectory outputted to the right region using the right thumb.

Although not shown in the drawing, if a touch on an arc trajectory menu is released within a predetermined time in the state in which the arc trajectory menu has been displayed, the terminal can support a function of releasing the display of the arc trajectory menu depending on setting. Furthermore, if a touch is released after a predetermined time elapses, the terminal determines a menu object disposed at the position where the touch was released and may support a function of executing the determined menu object.

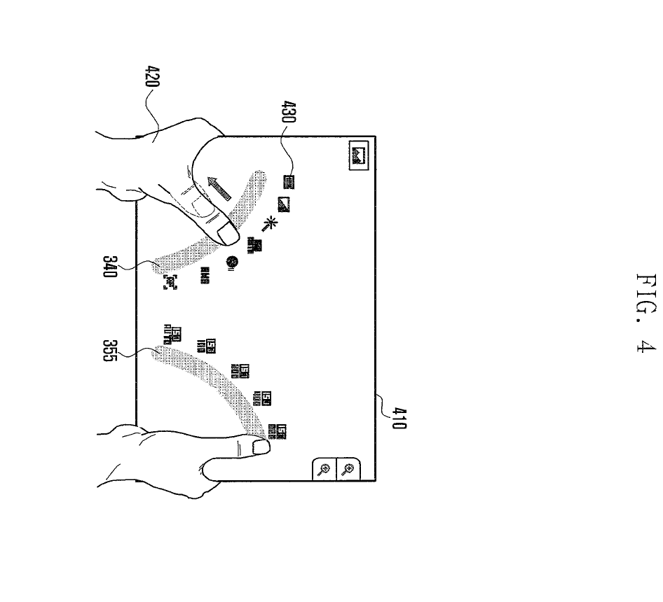

FIG. 4 illustrates an example diagram showing a user interface through which the display of an arc trajectory menu is fixed in accordance with the present disclosure.

As shown in FIG. 4, the display unit 112 can output a screen 410 in which an arc trajectory menu 430 related to a gallery application has been called in response to a request from a user.

Here, the arc trajectory menu 430 that includes information on the execution of function menus corresponding to the gallery application and an object (e.g., an icon) including menu information can be outputted. The arc trajectory menu 430 can be outputted to a limited region, that is, to a region in which the arc trajectory menu 430 can be touched by the thumb in the state in which a user holds the terminal 100 using a hand or both hands.

The user can move the thumb 420 in the central direction of an arc trajectory in the state in which the arc trajectory menu 430 has been called. In response thereto, the touch screen 110 generates a touch signal according to a change of the touch and transfers the generated touch signal to the control unit 170.

When the input operation of moving the thumb 420 in the central direction of the arc trajectory is detected, the terminal 100 executes a function of fixing the display of the arc trajectory menu 430. In such an embodiment, the terminal 100 may output an audio sound effect (e.g., a rattling sound) in order to inform the user that the menu display fixing function has been executed. Here, the fixing of the display of the arc trajectory menu 430 means that the display of the arc trajectory menu 430 is maintained although a touch is released in the state in which the arc trajectory menu 430 has been displayed.

If the arc trajectory menu 430 is fixed, the user can operate the arc trajectory menu 430 in the state in which the left hand is free. Thereafter, the user can execute manipulation functions related to the arc trajectory menu 430, such as entry into a lower menu and entry into an upper menu, by performing an operation of manipulating the arc trajectory menu 430 using the thumb in the state in which the display of the arc trajectory menu 430 has been fixed.

The photo function has been described as an example, for convenience of description. The construction of the present disclosure can be applied to all specific functions which can support menus using an arc trajectory, and the present disclosure is not limited thereto.

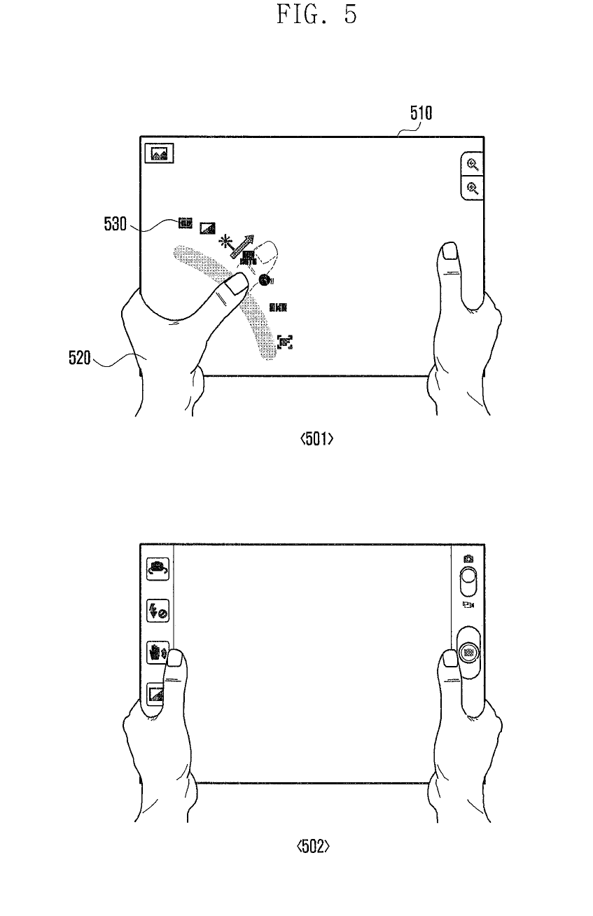

FIG. 5 illustrates an example diagram showing an operation of releasing an arc trajectory menu in accordance with the present disclosure.

Referring to FIG. 5, when the menu display fixing function of an arc trajectory is executed, the terminal 100 can support a function of outputting an arc trajectory menu 530 of a fixed state to the display unit 112 as shown in a screen 501.

A user can move a thumb 520 that has touched a screen 510 in the outside direction of the arc trajectory in the state in which the display of the arc trajectory menu 530 has been fixed. The terminal 100 detects the input operation of moving the thumb 520 in the outside direction of the arc trajectory. In response thereto, the terminal 100 executes a function of releasing the display of the arc trajectory menu 530 as shown in a screen 502. In such an embodiment, the terminal may output an audio sound effect (e.g., a rattling sound) in order to inform the user that the function of releasing the display of the arc trajectory menu has been executed, but the present disclosure is not limited thereto.

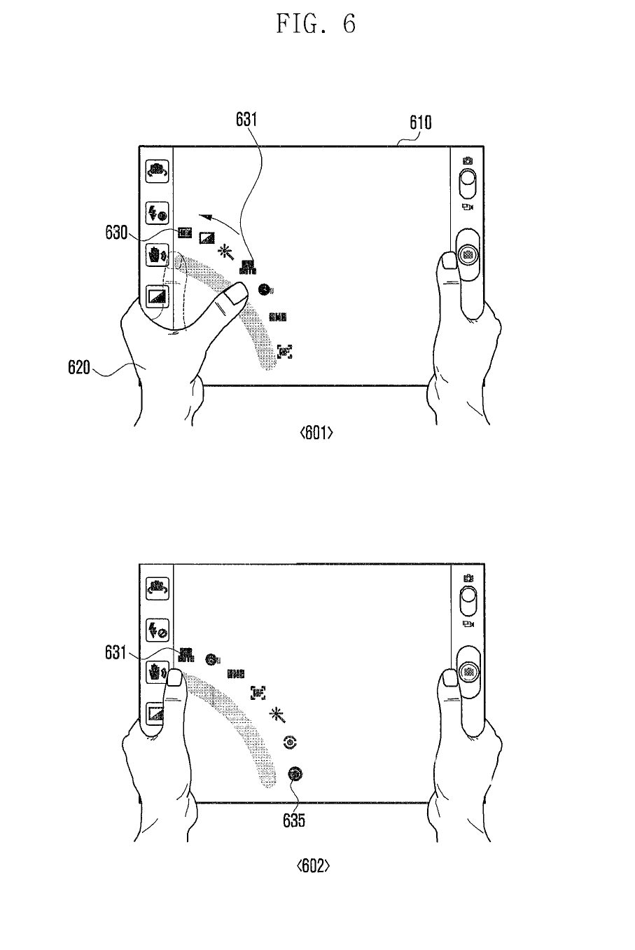

FIG. 6 illustrates an example diagram showing an operation of changing an arc trajectory menu in accordance with the present disclosure.

Referring to FIG. 6, when the menu display fixing function of an arc trajectory is executed, the terminal 100 can support a function of outputting an arc trajectory menu 630 of a fixed state on the display unit 112 as shown in a screen 601. The arc trajectory menu 630 can be outputted to a limited region, that is, a region in which the arc trajectory menu 630 can be touched by the thumb in the state in which a user holds the terminal 100 using a hand or both hands.

The user can move the thumb that has touched a screen 610 along an arc trajectory in the state in which the display of the arc trajectory menu has been fixed. The terminal 100 detects the input operation of moving the thumb along the arc trajectory. In response thereto, the terminal 100 executes a function of changing the arc trajectory menu as shown in a screen 602.

For example, the number of menu objects outputted to the display unit 112 of the terminal 100 may be limited due to a limited space of the display unit 112. Accordingly, an arc trajectory menu may include menu objects outputted to a display region and menu objects in a hidden region, that is, menu objects not outputted to the display region.

If a user performs an operation of moving the thumb along an arc trajectory, the terminal 100 can support a function of disposing menu objects, outputted to a display region along the arc trajectory, in a hidden region and outputting menu objects disposed in the hidden region to the display region.

In an embodiment, in the arc trajectory menu outputted to the screen 601, a first menu object 630 and a second object 631 are disposed in a display region. When a user inputs an operation of moving a touch along the arc trajectory, the terminal 100 changes the menu objects of the arc trajectory menu by sequentially moving the menu objects along the arc trajectory. That is, as shown in the screen 602, the first menu object 630 disposed in the display region is disposed in a hidden region, and the second menu object 631 is moved and disposed in the region in which the first menu object 630 had been disposed. Furthermore, a third menu object 635 disposed in a hidden region is disposed in the display region and outputted to the screen 610.

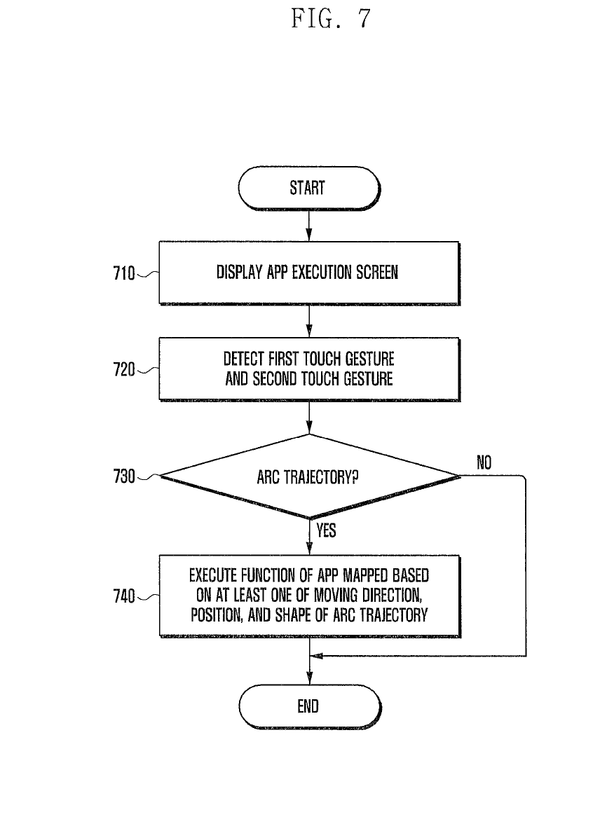

FIG. 7 illustrates a process for a method of operating an arc trajectory menu of the terminal 100 in accordance with an embodiment of the present disclosure.

Referring to FIG. 7, at operation 710, the terminal 100 displays an application execution screen on the terminal 100 or the display unit 112 according to a predetermined schedule. At operation 720, the terminal 100 detects a specific input event, that is, at least one touch gesture, in the touch screen in the state in which the application execution screen has been displayed. For example, the terminal 100 may detect a first touch gesture and a second touch gesture.

At operation 730, the terminal 100 determines whether or not the detected at least one touch gesture corresponds to an input operation drawn in an arc trajectory. The at least one touch gesture drawn in the arc trajectory may be different in the moving direction, position, and shape of the arc trajectory. At operation 740, the terminal 100 performs a specific function of an application that is mapped based on at least one of the moving direction, position, and shape of the arc trajectory detected based on the at least one touch gesture. Here, the terminal 100 can map information about the execution of a corresponding function to each of one or more touch gestures and store the pieces of information.

For example, the terminal 100 can support a function of outputting a specific photo to the display unit 112 in response to a request from a user. When at least one touch gesture drawn in an arc trajectory is detected through the touch screen in the state in which a specific photo has been displayed, the terminal 100 can support the execution of specific functions for the specific photo, such as an arc trajectory call function, a photo rotation function, a photo sharing function, and a cancellation function.

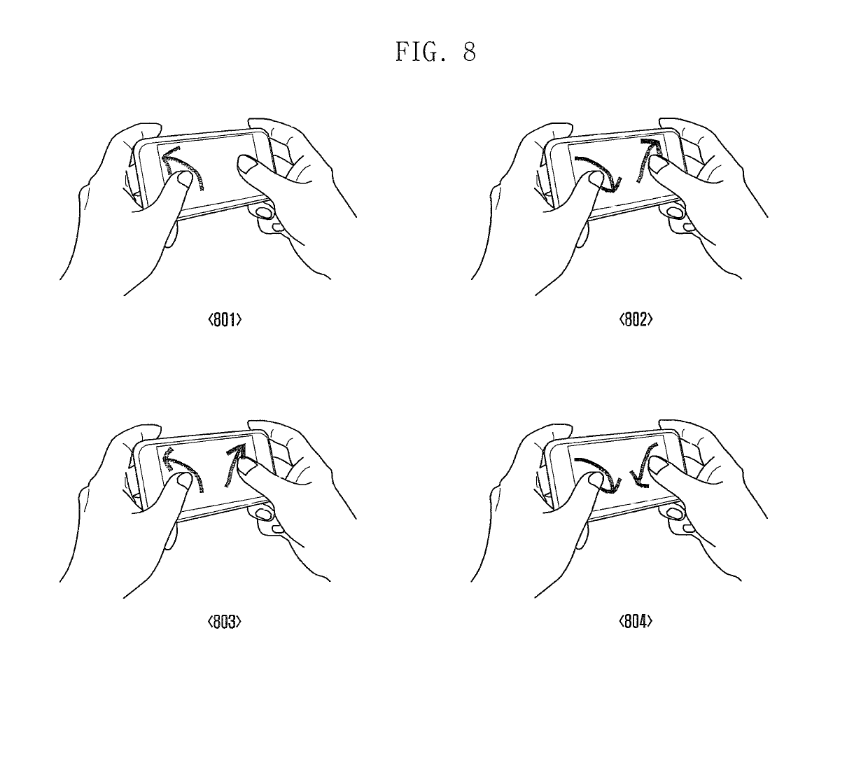

FIG. 8 illustrates an example diagram showing the operations of arc trajectory menus of the terminal in accordance with an embodiment of the present disclosure.

Referring to FIG. 8, the terminal 100 can detect a touch gesture drawn in at least one trajectory within a range in which a touch can be performed by the thumb of a user in the state in which an application has been executed. The terminal 100 can perform a function of an application that is mapped based on at least one of the moving direction, position, and shape of the at least one trajectory. That is, a user may perform touch gestures formed of various arc trajectories in the state in which the user holds the terminal 100 using both hands in a process of operating the terminal 100, as shown in screen 801 to screen 804.

For example, the terminal 100 may provide a screen in which a specific photo has been outputted to the display unit 112 in response to a request from a user. A user may input an operation of drawing an arc trajectory in a first direction using the thumb of the left hand in the state in which the specific photo has been outputted, as shown in the screen 801. The operation of drawing the arc trajectory in the first direction may be defined as an operation event for calling an arc trajectory menu. When a gesture, such as that shown in the screen 801, is generated, the terminal 100 can output an arc trajectory menu to the display unit 112.

A user may input an operation of drawing an arc trajectory from an upper direction to a downward direction using the thumb of the left hand and an arc trajectory from a downward direction to an upward direction using the thumb of the right hand in the state in which the user holds the terminal 100 using both hands, as shown in the screen 802. The operation of drawing the arc trajectories in the directions shown in the screen 802 may be defined as an operation event for rotating a specific photo outputted to the display unit 112. When gestures, such as those shown in the screen 802, are generated in the state in which a user holds the terminal 100 using both hands, the terminal 100 executes a function of rotating a specific photo outputted to the display unit 112.

A user may input an operation of drawing arc trajectories from a downward direction to an upward direction using the thumbs of the left hand and the right hand in the state in which the user holds the terminal 100 using both hands, as shown in the screen 803. The operation of drawing the arc trajectories in the directions shown in the screen 803 may be defined as an operation event for entering a menu in which a specific photo outputted to the display unit 112 is shared. When gestures, such as those shown in the screen 803, are generated in the state in which a user holds the terminal 100 using both hands, the terminal 100 may execute a sharing menu function of sharing an outputted photo with other users and output a corresponding execution screen. For example, the sharing menu function may include items, such as sending e-mail, sending a message, sending a social network messenger, storing a contact number, and designating a background screen, but the present disclosure is not limited thereto.

A user may input an operation of drawing arc trajectories from an upward direction to a downward direction using the thumbs of the left hand and the right hand in the state in which the user holds the terminal 100 using both hands, as shown in the screen 804. The operation of drawing the arc trajectories in the directions shown in the screen 804 may be defined as an operation event for cancelling the execution of a function. For example, if a user has rotated (e.g., rotation of 90 degree) a photo outputted to the display unit 112 by inputting gestures, such as those shown in the screen 802, the user can cancel the rotation function by inputting gestures, such as those shown in the screen 804.

In accordance with the present disclosure, a sense of stability according to the state in which a user holds an electronic device using both hands can be secured because an ability to operate the electronic device is maximized in the state in which the user holds the electronic device using both hands. Furthermore, in accordance with the present disclosure, when executing a function of the electronic device including the touch screen, the function can be intuitively set and function menus can be consecutively driven. Furthermore, the usability of an electronic device can be improved because entry and setting for a depth menu that involves several operations are facilitated.

The method and apparatus for operating a menu in a user device in accordance with some example embodiments of the present disclosure have been described above through the specification and drawings. Although specific terms are used, the terms are merely used according to their common meanings in order to easily describe the technical contents of the present disclosure and help understanding of the present disclosure, and the present disclosure is not limited to the aforementioned embodiments of the present disclosure.

Although the present disclosure has been described with an example embodiment, various changes and modifications may be suggested to one skilled in the art. It is intended that the present disclosure encompass such changes and modifications as fall within the scope of the appended claims.

What is claimed is:

1. A method of operating a menu in an electronic device, the method comprising:
displaying an execution screen of a specific function on a touch screen;
detecting a touch gesture comprising an arc trajectory in a state in which the execution screen has been displayed; and
displaying an arc trajectory menu related to the specific function in response to a touch gesture comprising the arc trajectory.

2. The method of claim 1, further comprises:
detecting a manipulation input gesture for an arc trajectory menu based on a touch input time and a touch movement in the state in which the arc trajectory menu has been displayed; and
executing a function of manipulating the arc trajectory menu in response to the manipulation input gesture for the arc trajectory menu.

3. The method of claim 2, wherein the executing of the function of manipulating the arc trajectory menu comprises executing at least one of a menu display fixing function, a menu display release function, a menu change function, a lower menu display function, and an upper menu display function in accordance with a touch input time and a touch movement of the touch gesture.

4. The method of claim 1, wherein the touch gesture comprising the arc trajectory is detected in a region in which a touch is performed using a thumb if the touch screen is held using both hands.

5. The method of claim 1, wherein the displaying of the arc trajectory menu comprises displaying the arc trajectory menu in a form in which at least one menu object related to the specific function is disposed in an arc trajectory.

6. The method of claim 2, wherein the executing of the function of manipulating the arc trajectory menu comprises fixing a display of the arc trajectory menu and displaying the fixed arc trajectory menu, if a touch is maintained for a predetermined time in the state in which the arc trajectory menu has been displayed and a touch movement for moving the touch in a central direction of the arc trajectory is detected.

7. The method of claim 2, wherein the executing of the function of manipulating the arc trajectory menu comprises releasing the display of the arc trajectory menu when a touch movement signal in an outside direction of the arc trajectory is detected in the state in which the arc trajectory menu has been displayed.

8. The method of claim 2, wherein the executing of the function of manipulating the arc trajectory menu comprises changing the arc trajectory menu and displaying the changed arc trajectory menu by disposing some of menus, outputted to a display region, in a hidden region and outputting some of menus, disposed in the hidden region, to the display region, when a touch movement signal in an arc direction of the arc trajectory is detected in the state in which the arc trajectory menu has been displayed.

9. The method of claim 1, further comprising:
detecting at least one touch gesture in which at least one of a moving direction, position, and shape of an arc trajectory is different in the state in which the execution screen of the specific function has been displayed; and
executing a function of the specific function mapped based on at least one of the moving direction, position, and shape of the arc trajectory.

10. An electronic device, comprising:
a touch screen configured to display an execution screen of a specific function and display an arc trajectory menu for the specific function; and
a control unit configured to detect a touch gesture comprising an arc trajectory in a state in which the execution screen of the specific function has been displayed and performing control such that an arc trajectory menu related to the specific function is displayed in response to a touch gesture comprising the arc trajectory.

11. The electronic device of claim 10, wherein the control unit is configured to detect a manipulation input gesture for an arc trajectory menu based on a touch input time and a touch movement in the state in which the arc trajectory menu has been displayed and perform control such that a function of manipulating the arc trajectory menu is executed in response to the manipulation input gesture for the arc trajectory menu.

12. The electronic device of claim 11, wherein the control unit is configured to perform control such that at least one of a menu display fixing function, a menu display release function, a menu change function, a lower menu display function, and an upper menu display function is executed in accordance with a touch input time and a touch movement of the touch gesture.

13. The electronic device of claim 10, wherein the control unit is configured to detect the touch gesture comprising the arc trajectory in a region in which a touch is performed using a thumb if the touch screen is held using both hands.

14. The electronic device of claim 10, wherein the touch screen displays the arc trajectory menu in a form in which at least one menu object related to the specific function is disposed in an arc trajectory.

15. The electronic device of claim 10, wherein the control unit is configured to perform control such that a display of the arc trajectory menu is fixed and the fixed arc trajectory menu is displayed, if a touch is maintained for a predetermined time in the state in which the arc trajectory menu has been displayed and a touch movement for moving the touch in a central direction of the arc trajectory is detected.

16. The electronic device of claim 10, wherein the control unit is configured to perform control such that the display of the arc trajectory menu is released when a touch movement signal in an outside direction of the arc trajectory is detected in the state in which the arc trajectory menu has been displayed.

17. The electronic device of claim 10, wherein the control unit is configured to perform control such that the arc trajectory menu is changed and the changed arc trajectory menu is displayed by disposing some of menus, outputted to a display region, in a hidden region and outputting some of menus, disposed in the hidden region, to the display region when a touch movement signal in an arc direction of the arc trajectory is detected in the state in which the arc trajectory menu has been displayed.

18. The electronic device of claim 10, wherein the control unit is configured to detect at least one touch gesture in which at least one of a moving direction, position, and shape of an arc trajectory is different in the state in which the execution screen of the specific function has been displayed and performs control such that a function of the specific function mapped based on at least one of the moving direction, position, and shape of the arc trajectory is executed.
